(19) United States
(12) Patent Application Publication
(10) Pub. No.: US 2003/0096567 A1
(43) Pub. Date: May 22, 2003

(54) Length unit with clip module

(75) Inventors: Georg Staudenrausch, Biberach (DE); Gerhard Mueller, Schemmerhofen (DE)

Correspondence Address: MARSHALL, GERSTEIN & BORUN, 6300 SEARS TOWER, 233 SOUTH WACKER, CHICAGO, IL, 60606-6357, US

(73) Assignee: Albert Handtmann Maschinenfabrik GMBH & Co. KG

(21) Appl. No.: 10/288,728

(22) Filed: Nov. 6, 2002

(30) Foreign Application Priority Data
Nov. 19, 2001 (EP) 01127565.8

(51) Int. Cl. A22C 11/02

(52) U.S. Cl. 452/37

(57) ABSTRACT

The invention refers to a device for the manufacture of sausages with a filling unit with a filling tube for filling sausage sleeves and a length unit for the controlled delivery of the filled sausage sleeves. In order to be able to simply and reliably close sausages of equal length and equal volume, in particular also with natural casings as the sausage sleeve, a clip module is arranged directly before the length unit in the transport direction of the filled sausage sleeves for closing the filled sausage sleeves.

The invention refers to a device and a method for the manufacture of sausages and a length unit for application of a device for the manufacture of sausages according to the preambles of claims 1, 12 and 22.

During automatic sausage manufacture filling machines are normally used. These filling machines insert sausage meat into a sausage sleeve through a filling tube. For this, the sleeve is located in a gathered up state directly on the filling tube or in an appropriate bush which is pulled over the filling tube. In general a so-called skin brake or a braking ring is located at the end of the filling tube. After the ejection of a portion of sausage from the filling tube, which corresponds to a single sausage, the sausage sleeve is twisted off with the aid of the braking ring gear and a twisting device. In order to press the sausage meat through the filling tube, an appropriate filling device is employed which transports the sausage meat into the filling tube intermittently. This type of filling machine is, for example, described in the European Patent EP 0232 812.

In order to ensure sausages are obtained with a constant length, a driven length unit follows the filling tube. This length unit pulls off the sausage sleeve from the filling tube through the braking ring. During the twisting off stage the sausage already filled is prevented by the length unit from turning with the rotated part of the sausage sleeve.

The length of the individual sausages can be defined by setting the delivery speed during sausage filling in relation to the filling ejection speed. The speed with which the filled sausage sleeve is delivered is set in dependence of a set filling-material ejection speed. This type of technique is described in the Pre-Published German Patent Application 24 02 817.

Closure of the sausage ends using so-called clippers is also already known. The closure of sausages by the clipper occurs either by closing the already manufactured, twisted-off sausages manually, which is however time consuming. It has already been suggested that a clipper is provided directly on the filling tube. With this technique the filled sausage sleeves are subdivided and closed by clipping into single sausages. However, it has been found that the use of this type of clipper directly on the filling tube has the disadvantage that the volume and the external shape of the single sausages is not adequately reproducible, in particular when natural sausage casings are used for the sausage sleeve. Firstly, the wall thickness and also the caliber are not constant with natural casings, so that different sausage shapes can arise. Secondly, a uniform external shape cannot be obtained due to the non-constant twisting properties with the non-uniform process of ejecting the filling material. Deformations at the ends of the sausage arise, because with the filled sausage sleeves the filling material is also compressed during clipping.

Starting from this prior art, the object of the invention is the provision of a device and a procedure for the manufacture of sausages with which the sausages can be simply enclosed, but sausages with the same length and volume—in particular also with natural casings as the sausage sleeve—can be manufactured in a simple and straightforward manner.

This object is resolved by the features of claims 1, 12 and 22.

This invention has the advantage that the filled sausage sleeves are passed in a controlled manner over a length unit and are thus brought into a certain shape so that they exhibit the same shape. Since the clip module is located in front of the length unit, the filled sausage sleeves can be very exactly subdivided into single sausages by the clip module, so that the sausages exhibit the same shape and exactly equal volume, even with the use of natural casings. Consequently, better weights are obtained with the cut product due to the constant filling caliber and better weights with chains of sausages, in particular with the first and last portion. Since the clip module is arranged in front of the length unit, even slow-moving or solid meat masses can be produced reliably in the process. With clipping before the conveyors of the length unit the mass is not pressed further into the clipped off portion, so that no cases split and no misshapen portions (e.g. thickening at the ends) can arise. Additionally required sausage sleeve can simply be pulled off from the filling tube by the length unit. Since the clip module is arranged in front of the length unit and not behind the length unit, the distance of the clipper from the twisting off point does not now need to be a multiple of the portion length, if the clip is to be applied exactly at the time at which the filling unit is stopped after the ejection of a portion. This is the prerequisite for the desired high weight accuracy. In addition, with the arrangement of the clip module according to the invention it is very easy to find the correct clipping point, because no summing length tolerances and therefore no position offsets can arise.

The clip module may include compression elements through the intervention of which the filled casing is subdivided.

A twisting off unit can be assigned to the filling tube such that closure through the clip module and the twisting off occurs at one point, i.e. with clipping in front of the conveyors of the length unit, the twisting off and the compression by the clipper can occur simultaneously, so that the portion is transported further between the conveyors synchronously with the filling stage. Therefore, within the portion no or only very little movement of the mass occurs relative to the sausage sleeve. Since the functions of twisting off and clipping can be superimposed, a higher portion throughput arises with the machine. With clipping in front of the length unit the twisting off point can be exactly obtained, because, in particular with chains of sausages with short portion lengths, no length tolerances add up and no position offsets arise. Consequently, it is ensured that the clip is always positioned at the correct twisting off point.

The twisting off unit and the clip module can be arranged and controlled such that the point of intervention of the compression elements corresponds to the twisting off point.

The clip module can incorporate a cutter so that the closure and cutting can take place in one unit to save space. Advantageously, the clip module also includes a loop-inserter for the sausages to be manufactured. The length unit can also be joined to a transfer unit which then passes the manufactured sausages to a transport device, e.g. a conveyor or a suspension device.

The filling unit, length unit and clip module are connected in an advantageous manner through control cables to a controller for the device for sausage manufacture. Consequently, the functions of the filling unit, length unit and clip module can run together synchronously. Furthermore, the transport device can be connected to the controller of the device for sausage manufacture in order to synchronize its functions with the functions of the filling unit, clip module and length unit.

It is advantageous if the clip module closes the filled sausage sleeve at two adjacent points, whereby the cutter of the clip module then cuts the filled sausage sleeves between the two points. The clip module can be controlled by the control device such that a cutter only operates after each nth closure so that chains of sausages with a certain number of sausages are obtained (n ε N).

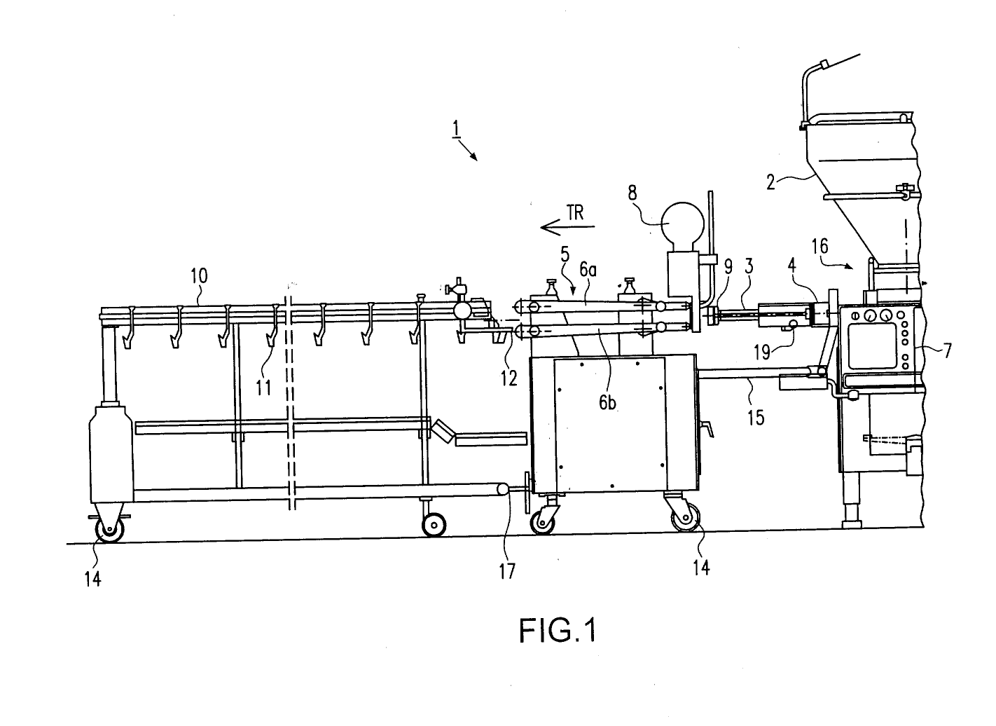

This invention is described below with reference to FIG. 1 which illustrates a device for the manufacture of sausages according to this invention.

The figure shows schematically an embodiment of the device according to the invention. A filling unit 16 incorporates a filling hopper 2 for the sausage meat and a filling tube 3. The sausage meat is ejected from the filling tube 3. For this, a sliding-vane pump, which is not illustrated, can be provided inside the filling unit 16. The filling tube 3 can be rotated about its own axis with the aid of the optionally provided twisting off device 4. At the end of the filling tube 3 a braking ring housing 9 is located, through which the sausage sleeve is pulled with the aid of the length device 5 while it is filled by the filling tube 3. The length unit 2 incorporates two endless drive belts 6a, 6b which, between them, transport the filled sausage sleeve. The endless belts 6a, 6b of the length unit 5 are driven by a drive which is not illustrated. In this embodiment the length unit is a separate unit which stands on rollers 14 and is therefore movable. The length unit 5 can be joined via a mounting 15 to the filling unit 16. A clip module 8 is arranged between the filling tube 3 and the length unit 5. The clip module 8 incorporates a clipper as employed in the meat processing trade for the provision of closures on sausages. Furthermore, the clip module 8 can also incorporate an integrated cutter for separating the individual sausages as well as a loop inserter. In the direction of transport TR behind the length unit 5 there is located a transfer unit 12 which passes on the closed sausages to a hanger unit 10 with a number of hooks 11. Alternatively to this, the transfer unit 12 can also pass the finished sausages to an outlet with a conveyor. The hanger unit 10 is also borne on rollers 14 and joined to the length unit 5 via a mounting 17.

The device for the manufacture of sausages also incorporates a controller 7. The controller 7 is connected by cables, which are not illustrated, to the filling unit 16, length unit 5, clip module 8 and hanger unit 10. It is therefore possible to control and synchronize the functions of the filling unit 16, length unit 5, clip module 8 and the transfer unit 12 or the following transport unit. The controller 7 is integrated into the filling unit 16.

Operation of such a device for the manufacture of sausages is described in the following:

In a manner already known, the braking ring housing 9 is swivelled away from the filling tube 3 with the aid of a swivel lever mechanism 19. Alternatively, the filling tube can also be pushed counter to the transport direction and swivelled to the side. A gathered-up sausage sleeve is fitted to the filling tube and the braking ring housing 9 is again swivelled back or alternatively, the filling tube is swivelled in again and pushed in the transport direction into the working position. The filling material, e.g. the sausage meat, is fed into the device through hopper 2. The sausage meat is pressed out of the filling tube 3 with the aid of the sliding-vane pump located in the filling unit 16 and the sausage meat fills the sausage sleeve. The sleeve is pulled by this action off of the filling tube 3. The length unit 5 which has been accurately aligned with the braking ring housing 9 via the rollers 14 and joined to the filling unit 16 via the mounting 15, then grasps the sausage sleeve with its endless belts 6a and 6b. The endless belts 6a and 6b are driven such that they move away from the filling tube 3. The maintenance of the necessary tension is provided by a braking ring located in the braking ring housing. The braking ring keeps the sausage sleeve under a slight tension when it is being pulled off the filling tube 3. The clip module 8, which is either, using a holder not illustrated, permanently arranged on the length unit 5 or is permanently attached to the braking ring housing, subdivides and closes the filled sausage sleeve into single sausages with a clip. The compression occurs using compression elements which move towards one another or engage in one another, throttling the filled sausage sleeve. With clipping before the conveyors 6a and 6b, the compression and closure by the clipper occurs simultaneously and the portion is transported further synchronously with the filling stage between the conveyors. Within the portion therefore, no or very little relative movement occurs between the mass and the sausage sleeve. Consequently, misshapen portions or skin splitting cannot arise and the sausage sleeve additionally required during the compression of the filling material can be simply pulled off from the spout. The single sausages or chains of sausages with a certain number of sausages are then transported in the transport direction TR via the length unit to the transfer unit 12 and transferred to it. The transfer unit 12 in turn transfers the single sausages or the chains of sausages to the hooks 11 of the hanger unit 10. Alternatively to this, the transfer unit 12 can also pass the single sausages or the chains of sausages to an outlet with conveyor. As already described, the functions of the clip module 8, i.e. closure, cutting off and inserting loops must be synchronized to the functions of the length unit, such as for example, speed of the conveyors 6a and 6b and to the functions of the filling unit 16, such as for example, ejected amount of filling material and speed of ejection of the filling material. In this way, an exact length of sausage with an accurately defined, reproducible filling volume can be manufactured according to the cycle of the clip module 8. With servo drive technology the portion throughput compared to the state of the art can be additionally increased. Also the transfer unit 12 or the following transport device is controlled via the controller 7 such that a continuous delivery of sausages is possible.

As an alternative to the previously described operation, the filling tube 3 of the filling unit 16, which ejects one portion of sausage meat for a single sausage, can be rotated, together with the gathered up sausage sleeve material which is not yet filled, by the twisting gear 4. Since the already filled sausage sleeve is held by the length unit 5 or its endless belts 6a and 6b, the sausage sleeve is tensioned in the direction of torsion. Through the action of the compression elements of the clip module, throttling of the filled casing occurs exactly at this point, leading to the formation of a single sausage. The clip module 8 can then close the single sausages at the throttle point. The arrangement of the clip module 8 before the length unit 5 makes it possible to easily and correctly find the twisting off point for clipping, because no length tolerances or position offsets can arise. In particular this arrangement enables the functions of twisting off, compression and clipping to be superimposed in time, leading to higher portion throughput for the machine. If twisting off and closure occur simultaneously through the clipper, then no or only very slight relative movement of the mass and the sausage sleeve occurs and therefore no skin splitting arises. As already described, additional sausage sleeve required can be simply pulled off from the spout.

The clipper 8 can also place two metal clips between two single sausages, whereby then, for example, a cutter can separate the sausages between the two clips. The cutter can cut, after each nth closure, adjacent sausages between the metal clips so that chains of sausages with a certain number of sausages can be produced.

This invention enables the processing of straight portions, single sausages, chains of sausages and semi-rings in non-soakable, gathered up artificial casings up to 7 cm in diameter and single sausages and chains of sausages in natural casings up to approx. 5 cm in diameter.

1. Device for the manufacture of sausages (1) with a filling unit (16) with filling tube (3) for filling sausage sleeves, a length unit (5) for the controlled delivery of the filled sausage sleeves, characterized in that a clip module (8) for closing the filled sausage sleeves is arranged in the transport direction of the filled sausage sleeves directly in front of the length unit (5).

2. Device according to claim 1, characterized in that the clip module (8) incorporates compression elements, through the action of which the filled sausage casings are subdivided.

3. Device according to claim 1, characterized in that a twisting off unit (4) is assigned to the filling tube (3) such that the closure by the clip module and the twisting off occur at one point.

4. Device according to claims 2 and 3, characterized in that the twisting off unit (4) and the clip module (8) are arranged such that the twisting off point occurs at the point of action of the compression elements.

5. Device according to at least one of the preceding claims, characterized in that the clip module (8) incorporates a cutter.

6. Device according to at least one of the preceding claims, characterized in that the clip module (8) includes a loop inserter.

7. Device according to at least one of the preceding claims, characterized in that a transfer unit (12) follows the length unit (5) in the transport direction of the filled sausage sleeves.

8. Device according to at least one of the preceding claims, characterized in that a transport device (10) follows the transfer device (12) in the transport direction of the filled sausage sleeves.

9. Device according to at least one of the preceding claims, characterized in that the transport device is a hanger unit (10) or a conveyor.

10. Device according to claim 1, characterized in that the filling unit (16), length unit (5) and the clip module (8) are connected through control cables to a controller (7) for the device for sausage manufacture, such that the functions of the length unit (5), clip module (8) and filling unit (16) can be synchronized.

11. Device according to claims 1, 5 and 8, characterized in that the transport device is connected to the controller for the device for sausage manufacture via control cables in order to synchronize its functions with the functions of the filling unit (16), length unit (5) and clip module (8).

12. Process for manufacturing sausages, whereby sausage sleeves are filled via a filling tube (3) and delivered in a controlled manner via a length unit (5), characterized in that the filled sausage sleeves are closed directly before the length unit (5) by a clip module (8).

13. Process according to claim 12, characterized in that the sausage sleeves are twisted off and closed by the clip module at the same point after filling before they are delivered via the length unit (5).

14. Process according to claim 12 or 13, characterized in that compression elements of the clip module (8) subdivide the filled sausage sleeve before closure or before twisting off.

15. Process according to one of the claims 12 to 14, characterized in that the clip module (8) is controlled by a controller (7) such that closure of the filled sausage sleeves occurs synchronously with the filling of the sausage sleeves.

16. Process according to one of the claims 12 to 15, characterized in that the clip module (8) closes the filled sausage sleeves at two adjacent points.

17. Process according to claim 16, characterized in that the clip module (8) cuts the filled sausage sleeves between the two points.

18. Process according to one of the claims 12 to 17, characterized in that cutting occurs after each nth closure in order to obtain sausage chains with a certain number of sausages (n ε IN).

19. Process according to at least one of the claims 12 to 18, characterized in that the filled sausage sleeves closed by the clip module (8) and delivered by the length unit (5) are passed to a transfer unit (12).

20. Process according to at least one of the claims 12 to 19, characterized in that the filled sausage sleeves are transferred after the transfer unit (12) in the transport direction to a transport device.

21. Process according to at least one of the claims 12 to 20, characterized in that the functions of the clip module (8) run synchronously to the functions of the length unit and the transport device.

22. Length unit for use with a device for manufacturing sausages (1) according to claim 1, characterized in that the length unit (5) incorporates a clip module (8) which is arranged at its front end in the transport direction of the sausages.
